(19) United States
(12) Patent Application Publication
(10) Pub. No.: US 2006/0165224 A1
(43) Pub. Date: Jul. 27, 2006

(54) Apparatus and method for managing network resources

(76) Inventor: Chur-Ung Lee, Suwon-si (KR)

Correspondence Address: Robert E. Bushnell;Suite 300, 1522 K Street, N.W., Washington, DC, 20005-1202, US

(21) Appl. No.: 11/296,775

(22) Filed: Dec. 8, 2005

(30) Foreign Application Priority Data
Dec. 10, 2004 (KR) 10-2004-0104505

(51) Int. Cl. H04M 3/22

(52) U.S. Cl. 379/16

(57) ABSTRACT

An apparatus and method of managing resources in a multi protocol label switching (MPLS) network. A separate database is provided that manages resources of network elements that make up the network. Upon receipt of an external call service request, a determination is made as to whether resources for a call service is available on the network by reference to the database. Thus, the process of checking with the network elements to determine the availability of resources is omitted.

### CLAIM OF PRIORITY

This application makes reference to, incorporates the same herein, and claims all benefits accruing under 35 U.S.C. §119 from an application for APPARATUS AND METHOD FOR MANAGING NETWORK RESOURCES, earlier filed in the Korean Intellectual Property Office on Dec. 10, 2004 and there duly assigned Serial No. 2004-104505.

### BACKGROUND OF THE INVENTION

1. Field of the Invention

The present invention relates to resource management for call processing in a network, and more particularly, to an apparatus and method of managing resources in a multi protocol label switching (MPLS) network.

2. Description of the Related Art

To perform call service, a network should have sufficient resources available. Hence, it is common that upon occurrence of a call service request, the network first checks whether sufficient resources to provide the call service are available on the network, and if present, provides the call service. Functions associated with network resources, such as checking whether resources for a call service are available, are hereinafter referred to as resource management.

In a quality-of-service (QoS) guaranteed network such as a multi protocol label switching (MPLS) network, resource management is becoming increasingly important. This is because the QoS guaranteed network has to allocate a different required amount of resources as requested by each call, unlike a best-effort network which allocates the same amount of resources to every call. Here, the resources are typically bandwidth (BW).

In resource management, determination of grant or access of a call is based on whether enough resources are currently available for the call. In order to find out if enough resources are available, individual network elements (NEs) are polled. This requires a bandwidth manager (BM) to transmit and receive messages with the respective NEs in order to check whether an amount of resources needed for the call service is available on the network. Such message transmission and reception between the BM and the NEs has to be performed each time the BM receives the request for call service. This cuts into processing speed while increasing load. Therefore, what is needed is an apparatus and a method of determining whether enough resources are available for a call without causing such a drain on processing speed and without causing an increase in load. SUMMARY OF THE INVENTION

It is therefore an object of the present invention to provide an improved apparatus that manages resources in an MPLS network.

It is also an object of the present invention to provide an improved method of managing resources in an MPLS network.

It is further an object of the present invention to provide an apparatus that manages resources in an MPLS network that does not reduce processing speed and does not increase load.

It is yet an object of the present invention to provide a method of managing resources in an MPLS network that does not reduce processing speed and does not increase load.

These and other objects can be achieved by a resource managing apparatus that includes a separate component for storing network resource information and manages network resources using the component, such that a determination can be made as to whether there is enough resources for granting a requested call service is available on the network is determined without checking with network elements. In the present invention, the component for storing the network resource information is referred to as a resource manager.

According to one aspect of the present invention, the apparatus includes at least one network element in a network, a call server, a resource manager adapted to store resource information received from the at least one network element and adapted to determine whether resource allocation is possible in response to a resource allocation request by referring to the stored resource information, and a call control manager adapted to inquire (or ask) the resource manager as to whether resource allocation is possible, receive an answer from the resource manager, and transmit the answer to the call server upon receipt of the resource allocation request from the call server

According to another aspect of the present invention, there is provided a method that includes providing at least one network element in a network, a call processor adapted to manage resource information of the at least one network element, and a call server, receiving, by the call processor, a resource allocation request from the call server, determining whether or not to grant the resource allocation request by checking whether an amount of resources requested by the request is available on the network, and transmitting to the call server a message indicating whether or not the resource allocation request is granted

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view of a diagram showing the configuration of a multi protocol label switching (MPLS) network managed by a bandwidth manager that is a resource managing apparatus;

FIG. 2 is a view of a diagram showing the configuration of a network including a resource managing apparatus according to the present invention; and

FIG. 3 is a view of a diagram illustrating a signal flow according to the present invention.

### DETAILED DESCRIPTION OF THE INVENTION

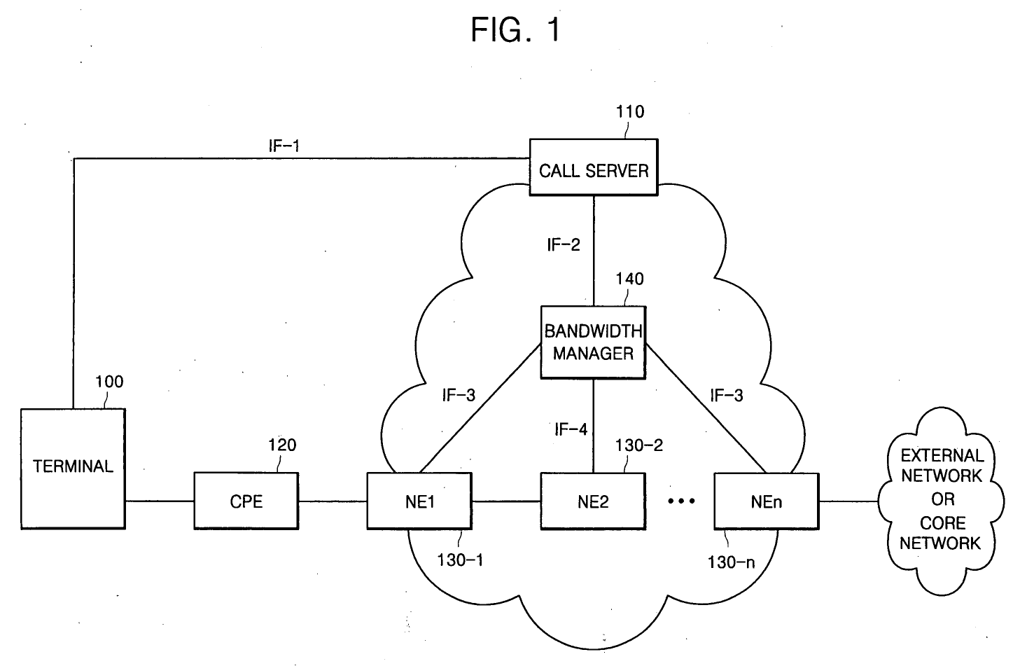

Resource management in a MPLS network will now be described with reference to FIG. 1. FIG. 1 is a diagram showing the configuration of an MPLS network managed by a bandwidth manager, which is a resource managing apparatus. As shown in FIG. 1, the network includes a terminal 100, a call server 110, a customer premises equipment (CPE) router 120, network elements (NE) NE1 130-1 to NEn 130-n, and a bandwidth manager (BM) 140. The NE1 130-1 and NEn 130-n of the NEs 130-1 to 130-n, which are located at ends of the network in FIG. 1, may be connected to terminal 100 or another network. Receiving and transmitting a call from or to the network maybe done via NE1 130-1 and NEn 130-n located at the ends of the network. Hereinafter, NE1 130-1 and NEn 130-n located at the ends of the network, as well as NE2 130-2 located at a core of the network, are all simply referred to as NEs, except when there is particular need to distinguish them.

In FIG. 1, the BM 140 performs resource management for dynamic quality of service (QoS) control in the network. The BM 140 provides admission control for various differential forwarding classes and activates resources by means of a provided traffic conditioner (filters, token bucket shapers, and markers). The BM 140 accepts or refuses a request to provide bandwidth for service of a call incoming from the call server 110, depending on the availability of network resources.

The BM 140 is connected to the call server 110 and to the NEs 130-1 to 130-n and serves as network infrastructures for performing the two following functions. First, the BM 140 sets up and maintains an aggregate reservation needed for call service using an interface-4 (IF-4). Second, the BM 140 enables utilization of aggregate resources for each call using IF-2 and IF-3. The BM 140 allows traffic to be delivered through a bandwidth (BW) pipe, e.g., a label-switched path (LSP) in the MPLS network, which is set up between the ends of the network and is capable of accommodating a number of calls, and provides an aggregate reservation for call service. The components and the interfaces shown in FIG. 1 are defined in the Multiservice Switching Forum (MSF) QoS solution framework.

When receiving a request for call service from outside (e.g., the call server 110), the BM 140 checks through the following resource management process whether the call service is available. Upon a receipt of the request for the call service, the BM 140 transmits a message to the NEs to check whether an amount of resources required for the call service is available on the network, and receives response messages from the NEs 130-1 through 130-n containing network resource state information, and checks an amount of the network resource by referring to the response message. If the amount of network resources are more than is needed for the requested call service, the BM 140 determines that the call service is available. If the amount of the network resources are less than is needed for the requested call service, the BM 140 determines that the call service is unavailable.

In other words, in resource management scenario of FIG. 1, upon receipt of an external request for call service, the BM 140 has to transmit and receive messages with the respective NEs 130-1 through 130-n in order to check whether an amount of resources needed for the call service available on the network. Such message transmission and reception between the BM 140 and the NEs 130-1 through 130-n should be performed each time the BM 140 receives the request for call service, leading to a degradation of call processing speed while increasing load.

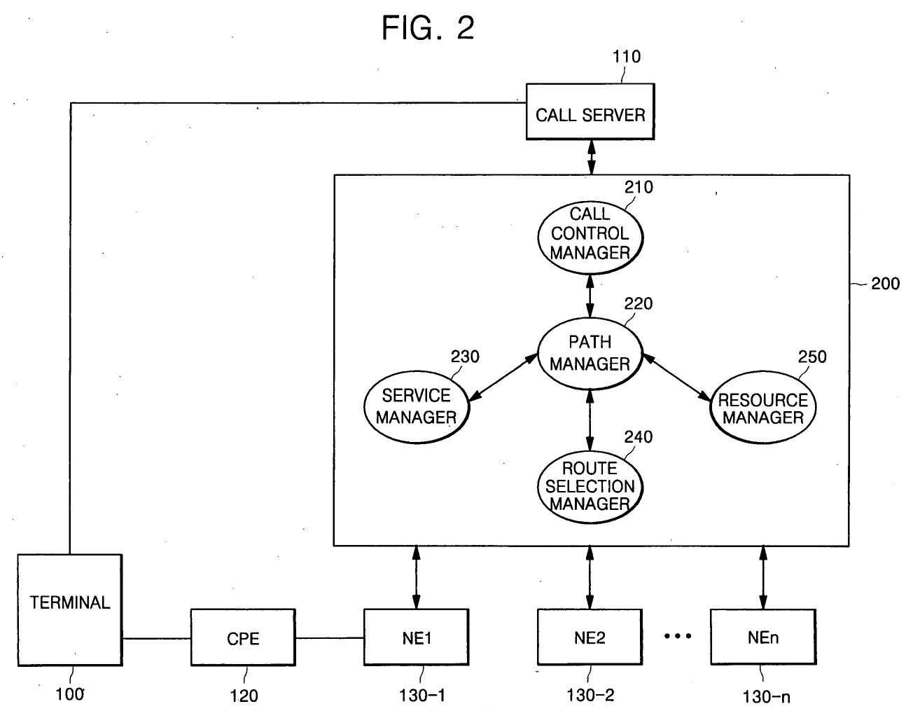

Turning now to FIG. 2, FIG. 2 is a diagram showing the configuration of a network including a resource managing apparatus 200 (or call processor 200) according to the present invention. As shown in FIG. 2, the network according to the present invention may include a terminal 100, a call server 110, a CPE 120, NE1 130-1 to NEn 130-n, and a resource managing apparatus 200. For example, an MPLS switch corresponds to NE1 130-1 to NEn 130-n.

Terminal 100 of FIG. 2 is preferably, but not necessarily, a terminal with session initiation protocol (SIP). Terminal 100 is able to request the network to provide call service, such as transmitting traffic (e.g., MPLS traffic) over the network. The call service is made via a connection between the network and terminal 100 while requesting the call service via the call server 110. That is, when desiring to receive call service over the network, terminal 100 first requests the call server 110 to provide the call service. If terminal 100 is an SIP terminal, terminal 100 may request the call server 110 to provide the call service by use of an SIP message. Otherwise, terminal 100 may request the call server 110 to provide the call service by use of means suitable for each terminal. A detailed description of this is omitted.

Terminal 100, which requests the call server 110 to provide the call service, begins to receive call service over the network by receiving, from the call server 110, a signal indicating that the call is accepted along with information needed for the call service. It will be easily understood that terminal 100 is unable to receive the call service if a signal refusing to provide the requested call service is received from the call server 110. There may be several reasons for refusing to provide the call service requested by terminal 100. The present invention is concerned with the particular cases of the service request being refused when a network resources are insufficient or when a delivery path (e.g., an LSP in an MPLS) capable of delivering traffic for call service requested by a terminal is not present on the network.

Upon receipt of a call service request from terminal 100, the call server 110 sends to the resource managing apparatus (or call processor) 200 a message inquiring whether the call service is accepted or granted. Call server 110 then receives an answer from the resource managing apparatus 200, and transmits the answer to terminal 100 requesting the call service. In this case, a message transmitted and received between the call server 110 and the resource managing apparatus 200 may be a network resource control protocol (NRCP) message. The NRCP message will be described in greater detail later.

When receiving from the call server 110 a message inquiring whether the call service is available, the resource managing apparatus 200 checks using information contained in the received message whether the network is in a state capable of providing the call service. According to the result, the resource managing apparatus 200 transmits a message to the call server 110 indicating whether it accepts or refuses to provide the call service.

A configuration of the resource managing apparatus 200 of the present invention will be now described. The resource managing apparatus 200 may include a call control manager (CCM) 210, a path manager (PM) 220, a service manager (SM) 230, a route selection manager (RSM) 240, and a resource manager (RM) 250, as shown in FIG. 2.

The call control manager 210 performs message transmission and reception with the call server 110. The path manager 220 performs path establishment and path management on the network, the service manager 230 manages, for example, a class of service over the network, and the route selection manager 240 selects a network path that is most suitable for call service. The resource manager 250 stores and manages resource information on the network.

In the present invention, the call control manager 210 and the resource manager 250 will be described but the selection manager 240 and the service manager 230 will not. The path manager 220 will also be briefly described later. In the present invention, the resource manager 250 receives, stores, and manages connection information, resource state information, and the like from NE1 130-1 to NEn 130-n. Data stored in and managed by the resource manager 250 is hereinafter referred to as “resource information”. Typically, the resource manager 250 may be implemented in the form of a database. The resource information may include information such as path information, source address (SA), destination address (DA), ingress address, egress address, NE node ID, NE interface ID, a total amount of network resource (or, total BW), an amount of used resource (or, reserved BW), and a remaining amount of resources (or, unreserved BW). Here, bandwidth (BW) is a representative resource.

NE1 130-1 to NEn 130-n transmit their connection information, resource state information, and the like to the resource manager 250 of the resource managing apparatus 200. Simple network management protocol (SNMP) may be used to transmit such information. In an initial operation of the network, NE1 130-1 to NEn 130-n transmit connection information, resource state information, and the like to the resource manager 250 so that the resource manager 250 produces the resource information. NE1 130-1 to NEn 130-n then are able to update the resource information of the resource manager 250 by transmitting connection information, resource state information, and the like to the resource manager 250 periodically or when a change such as path disconnection occurs in the network. Updating the resource information may be performed by a policy that is preferably selected according to network features.

When the resource manager 250, which produces and stores resource information using information received from NE1 130-1 to NEn 130-n, receives an inquiry from the call control manager 210 as to whether a call service is available, the resource manager 250 compares an amount of resources needed for the call service to the stored resource information. The resource manager 250 determines that the call service is available when an available amount of resources indicated by the resource information is more than is needed for the call service. Otherwise, the resource manager 250 determines that the call service is unavailable. When resources are available, it will be easily understood that a path capable of providing the call service should be present on the network. When a path is not available, the resource manager 250 determines that the call service is unavailable. The resource manager 250 outputs a signal to the call control manager 210 indicating whether the call service is accepted or granted. When refusing to provide the call service, the resource manager 250 may output a message to the call control manager 210 including information indicating whether the refusal is due to insufficient network resources due to lack of a path for the call service.

The path manager 220 may be used to establish a new path on the network capable of performing the call service when there is no path available for performing the requested call service. A determination as to whether to establish the new path may be made by the call control manager 210. When the same call service request that is refused due to lack of a path is received more than a predetermined number of times, the call control manager 210 enables a path for the call service to be established so that the call service is performed. This is because a call attempted more than a predetermined number of times is assumed to be an important call. This requires that the call control manager 210 be able to record and keep track of the number of times a call is refused.

The above described components, the NRCP message (described below), and the like are defined in “Multiservice Switching Forum (MSF) QoS solution framework”. The NRCP message X used in the present invention will be now described. While resource allocation includes two-phase resource allocation and single-phase resource allocation, the following description is concerned with an embodiment of the present invention using the single-phase resource allocation.

The NRCP message can be any of six messages: reservation and commit request (RESVCM_REQ), reservation and commit reply (RESVCM_REPLY), modify reservation request (MODIFY_REQ), modify reservation reply (MODIFY_REPLY), release reservation request (RELEASE_REQ), and release reservation reply (RELEASE_REPLY).

Mandatory parameters of the RESVCM_REQ message include the following parameters: bandwidth (BW), Service, Priority, Source Address (SA), Source Mask Length (SML), Destination Address (DA), Destination Mask Length (DML), Source Port (SP), Destination Port (DP), and Protocol. The RESVCM_REQ message is used to request new call service. The RESVCM_REQ message is transmitted by the call server 110 to the resource managing apparatus 200.

A mandatory parameter of the RESVCM_REPLY message is ID. Here, ID is unique to each reservation allocated by the resource managing apparatus 200. The RESVCM_REPLY message is transmitted by the resource managing apparatus 200 to the call server 110 as a response to the RESVCM_REQ message. The RESVCM_REPLY message may contain an indication as to whether the call service requested by the call server 110 is accepted.

Mandatory parameters of the MODIFY_REQ message are ID and BW, and a mandatory parameter of the MODIFY_REPLY message is ID. The MODIFY_REQ message is a signal requesting change in an amount of resources allocated to an ongoing call, and the MODIFY_REPLY message is a response to the MODIFY_REQ message.

A mandatory parameter of the RELEASE_REQ message is ID, and a mandatory parameter of the RELEASE_REPLY message is also ID. The RELEASE_REQ message requests release of an ongoing call, and the RELEASE_REPLY message is a response to the RELEASE_REQ message.

Here, the REQ messages are transmitted by the call server 110 to the resource managing apparatus 200, and the REPLY messages are transmitted by the resource managing apparatus 200 to the call server 110. The BW information contained in the messages is representative resource information.

In the present invention, when a change in an amount of the network resource occurs due to initiating new call service, modifying an ongoing call, terminating an ongoing call, and the like through these messages, the resource manager 250 updates the resource information by reflecting the change in the stored resource information. For example, the resource manager 250 is able to update the resource information by subtracting an amount of resources allocated for new call service from an available amount of network resources, and by adding an amount of resources made available for other call service due to termination of a call service to the available amount of resources.

As a detailed example, a case will be described where a voice over IP (VoIP) telephone, as terminal 100, requests a call service requiring a 484 Kbyte bandwidth. The VoIP telephone first requests the call server 110 to provide the call service. The VoIP telephone transmits its desired bandwidth information together with a request for the call service to the call server 110. The call server 110 receives the request to provide the call service from the VoIP telephone and requests the resource managing apparatus 200 to provide the call service. The call control manager 210 of the resource managing apparatus 200 asks the resource manager 250 whether the requested call service is available, and more specifically, whether an available amount of resources on an LSP is sufficient for the call service. The resource manager 250 compares an amount of resources required for the requested call service to the stored available amount of resources in order to determine whether the call service is available. If the available amount of resource is 500 Kbytes, which is greater than the 484 Kbytes needed for the call, the resource manager 250 determines that the call service is available. The resource manager 250 outputs to the call control manager 210 the determination result that the call service is available, and updates the available amount of resources to 16 Kbytes, which is obtained by subtracting 484 Kbytes from 500 Kbytes. On the other hand, if the available amount of resources is 400 Kbytes, which is smaller than the 484 Kbytes needed for the call, the resource manager 250 determines that the call service is unavailable and outputs the determination result to the call control manager 210. The call control manager 210, which receives the determination result from the resource manager 250, transmits a message to the call server 110 indicating whether the call service is available. In this case, the call server 110 and the resource managing apparatus 200 may communicate using NRCP messages.

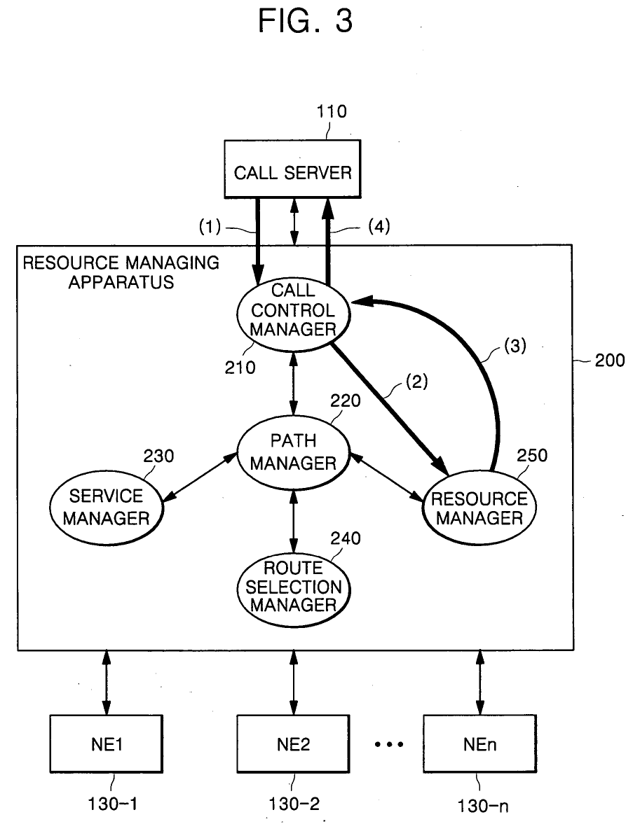

FIG. 3 is a diagram illustrating a message flow according to the present invention. In FIG. 3, “(1)” indicates a request message the call server 110 transmits to the call control manager 210 of the resource managing apparatus 200. The request message (1) may be one of a RESVCM_REQ message, a MODIFY_REQ message, and a RELEASE_REQ message. The call control manager 210 outputs information (2) contained in the message (1) to the resource manager 250. When the message is a message requesting a new call service or a message requesting call modification, the resource manager 250 determines whether to grant the request and outputs a message (3) indicating the determination result to the call control manager 210. Further, when accepting the new call service request or the call modification request, the resource manager 250 updates its stored resource information by reflecting a change in the resource amount. Meanwhile, if the message (2) is a message requesting termination of a call, the resource manager 250 updates its stored resource information by reflecting a change in the resource amount caused by the call termination. The call control manager 210 transmits to the call server 110, a response message (4) in response to the message (1) by referring to the message (3) received from the resource manager 250.

A resource management process according to the present invention will now be described with reference to FIGS. 2 and 3, in which the NRCP message is used. In the following description, BW is used in resource management according to the present invention.

A process in which a normal response is made to the RESVCM_REQ message and the MODIFY_REQ message will be described first. The call control manager 210, which receives the RESVCM_REQ message from the call server 110, checks whether BW is available on an LSP, based on a source address (SA) and a destination address (DA) in the message and through cooperation with the resource manager 250. The resource manager 250 stores, maintains, and manages resource information including resource information of all LSPs established within the MPLS delivery network. If the BW is found to be present on an LSP by checking with the resource manager 250, the call control manager 210 transmits the RESVCM_REPLY message to the call server 110 indicating that sufficient resources are available.

Meanwhile, the resources that have been utilized for the call service should be released after the call service is completed. In this case, the call server 110 transmits a MODIFY_REQ message to the call control manager 210. The call control manager 210, which receives the MODIFY_REQ message from the call server 110, asks the resource manager 250 whether the BW needed to perform the call modification requested by the message is available on the LSP, through BW, SA and DA in the message. Upon receipt of a response from the resource manager 250 indicating that there is enough BW to normally perform the call modification requested by the message, the call control manager 210 transmits a MODIFY_REPLY message in the affirmative to the call server 110.

Next, a case where a new call service requested by the call server 110 is refused will be described. The call control manager 210 refuses to provide the requested new call service by sending an error message to the call server 110 when an LSP for the requested call service is not present within the network or when BW within an LSP is insufficient for the requested call service.

The first case of no LSP present will be described first. In this first case, since the LSP for the call service, which is requested by the call server 110 transmitting an RESVCM_REQ message to the call control manager 210, is not present in the network, the call control manager 210 transmits an error message to the call server 110 and leaves a record regarding LSP refusal. In the error message transmission, the call control manager 210 may set an error code value of the error message as “Reservation Denied” and an error string value as “No LSP”. Meanwhile, if a request for a call requiring the use of a specific nonexistent LSP is received a critical number of times, the call control manager 210 requests the path manager 220 to establish the LSP in the network. The path manager 220, which receives the request to establish the LSP from the call control manager 210, cooperates with the resource manager 250 to compute a route and establish the LSP. The path manager 220 outputs the formed information to the resource manager 250 so that the resource manager 250 updates its resource information and notifies the call control manager 210 that the requested LSP is established. The call control manager 210, which is notified by the path manager 220 via the resource manager 250 that the LSP is established, transmits the RESVCM_REPLY message to the call server 110 giving notice that the BW on the relevant LSP is reserved and that the call service over the LSP is accepted. On the other hand, the call control manager 210 may instead be configured not establish a nonexistent LSP that is requested a predetermined number of times depending on network policy. In this case, the call control manager 210 does not have to record the number of call refusals.

The second case where insufficient BW is present will now be described. In the second case, since an LSP is available for call service requested by the call server 110 transmitting the RESVCM_REQ message to the call control manager 210, but the LSP has insufficient BW, the call control manager 210 sends an error message to the call server 110 and leaves a record regarding the LSP refusal. In the error message transmission, the call control manager 210 may set an error code value of the error message as “Reservation Denied” and an error string value as “Insufficient BW”. If the call control manager 210 receives a call request for the LSP more than a critical number of times, the call control manager 210 requests the path manager 220 to increase the BW of the LSP. It will be easily understood that whether or not to increase the BW of the LSP after a predetermined number of refusals may be determined according to network policy.

Meanwhile, a MODIFY_REQ message is used to modify BW being used by an ongoing call. For modification requests, request refusals occur only when insufficient BW is available in the requested LSP. There is never a refusal when the BW currently being used by the call is greater than the modified BW. However, when the modified BW is greater than the BW being currently used by the call, it is necessary to determine whether or not there is enough resources available on the network to perform the modification. For example, such a determination is made when a user of a voice over IP (VoIP) call attempts to start using a video telephone. The call control manager 210, which receives the MODIFY_REQ message from the call server 110, sends an ERROR message to the call server 110 to refuse such a request to modify the resources when the available BW is insufficient on the LSP that the call is currently being serviced. Meanwhile, even when such a call modification is denied, the call control manager 210 retains information about the message requesting to modify the resources and, if the request is made more than a critical number of times, the call control manager 210 requests the path manager 220 to increase BW of the LSP. A subsequent process of increasing the BW of the LSP is the same as with the RESVCM_REQ message.

As described so far, the present invention allows network resources to be checked based on resource information stored and managed by the resource manager 250, without message communication with NE1 130-1 to NEn 130-n to determine whether resources needed to provide the requested call service is available on the network. The present invention enables network resource management without performing a message transmission and reception process with network elements, thus improving resource management speed for call service and reducing load.

While the present invention has been particularly shown and described with reference to an exemplary embodiment thereof, it will be understood by those of ordinary skill in the art that various changes in form and detail may be made therein without departing from the spirit and scope of the present invention as defined by the following claims and their equivalents.

What is claimed is:

1. An apparatus, comprising:
at least one network element in a network;
a call server;
a resource manager adapted to store resource information received from the at least one network element and adapted to determine whether resource allocation is possible in response to a resource allocation request by referring to the stored resource information; and
a call control manager adapted to inquire the resource manager as to whether resource allocation is possible, receive an answer from the resource manager, and transmit the answer to the call server upon receipt of the resource allocation request from the call server.

2. The apparatus of claim 1, wherein the resource manager is further adapted to compare an available amount of network resources indicated by the stored resource information to a requested amount of network resources in the resource allocation request and to determine that the resource allocation is possible when the available amount of network resources is more than the requested amount of network resources.

3. The apparatus of claim 2, wherein the requested network resources is at least one of resources for a new call service and resources for modification of an amount of resources allocated to an existing call service.

4. The apparatus of claim 3, wherein the resources are bandwidth.

5. The apparatus of claim 1, wherein each of the at least one network element is adapted to transmit the resource information to the resource manager using simple network management protocol (SNMP).

6. The apparatus of claim 1, wherein each of the at least one network element is adapted to transmit their resource information to the resource manager upon initial network operation.

7. The apparatus of claim 1, wherein each of the at least one network element is adapted to transmit their resource information to the resource manager when a change in the network occurs.

8. The apparatus of claim 1, wherein the at least one network element periodically transmits their resource information to the resource manager.

9. The apparatus of claim 1, wherein the resource manager is adapted to manage the resource information in real time by subtracting an allocated amount of resources from the resource information, and adding an amount of resources that is made re-available following allocation to the resource information.

10. The apparatus of claim 4, wherein the resource information stored in the resource manager comprises at least one of a source address, a destination address, an ingress address, an egress address, a network element node identifier (NE Node ID), a network element interface identifier (NE Interface ID), a total amount of network resource, an allocable amount of network resource, and an allocated amount of network resource.

11. An apparatus, comprising:
at least one network element;
a call server;
a resource manager adapted to store resource information received from the at least one network element and adapted to determine whether a request for resource allocation is possible by referring to the stored resource information; and
a call control manager adapted to output a state of a requested resource to the resource manager and to relay a response message from the resource manager to the call server that indicates whether the request for resource allocation is possible upon receipt of a network resource control protocol (NRCP) message comprising the request for resource allocation from the call server.

12. The apparatus of claim 11, wherein the NRCP message is one of a message requesting resource allocation for new call service (RESVCM_REQ Message), a message requesting resource allocation for modification to an ongoing call (MODIFY_REQ Message), and a message requesting return of an allocated resource upon termination of an ongoing call (RELEASE_REQ Message).

13. The apparatus of claim 12, wherein the message requesting resource allocation of resources for new call service comprises call-related information that is at least one of bandwidth required for the call service, service class, priority, a source address, a destination address, an ingress address, and an egress address.

14. The apparatus of claim 12, wherein the message requesting resource allocation for modification of an ongoing call comprises call-related information having an identifier of a call to be modified and a requested modified bandwidth.

15. The apparatus of claim 12, wherein the message requesting return of an allocated resource upon termination of an ongoing call comprises call-related information having an identifier of a call to be terminated.

16. The apparatus of claim 12, wherein the call control manager notifies the call server whether the requested resource allocation is possible via an NRCP response message.

17. An apparatus, comprising:
at least one network element in a network;
a call server;
a resource manager adapted to store resource information received from the at least one network element and adapted to determine whether resource allocation is possible in response to a resource allocation request by referring to the stored resource information;
a path manager adapted to establish a new path on the network; and
a call control manager adapted to, upon receipt of the resource allocation request from the call server, inquire the resource manager as to whether the resource allocation is possible, and when the resource allocation is refused due to nonexistence of a path needed to allocate the requested resource, check whether resource allocation request for the path has been received more than a predetermined number of times, and when the request is found to be received more than a predetermined number of times, instruct the path manager to establish the path.

18. The apparatus of claim 17, wherein the call control manager is further adapted to, upon the receipt of the resource allocation request from the call server, inquire of the resource manager as to whether the requested resource allocation is possible, and when the resource allocation is refused due to an insufficient amount of resources on the path, check whether the resource allocation request has been received more than a predetermined number of times, and when the request is found to be received more than a predetermined number of times, increase the resource amount of the path.

19. The apparatus of claim 17, wherein the call control manager is further adapted to transmit a message indicating that the resource allocation request is accepted to a correspondent requesting the call service via the established path.

20. A system, comprising:
a plurality of network elements in a network, the plurality of network elements being adapted to transmit their resource information according to a network policy;
a resource managing apparatus; and
a call server adapted to receive a resource allocation request from a terminal and adapted to transmit a resource allocation request to the resource managing apparatus, the resource managing apparatus being adapted to store the resource information received from the plurality of network elements and to determine, based on the stored resource information, whether the resource allocation request is granted.

21. The system of claim 20, wherein the resource managing apparatus is further adapted to grant the resource allocation request when a requested resource in the resource allocation request is less than available resource indicated by the stored resource information.

22. The system of claim 20, wherein the resource managing apparatus is further adapted to manage the resource information in real time by subtracting an allocated amount of resources from the resource information, and adding an amount of resources that is made re-available following an allocation of resource information.

23. The system of clam 20, wherein the plurality of network elements are further adapted to transmit their resource information periodically and to the resource managing apparatus.

24. A method, comprising:
providing at least one network element in a network, a call processor adapted to manage resource information of the at least one network element, and a call server;
receiving, by the call processor, a resource allocation request from the call server;
determining whether or not to grant the resource allocation request by checking whether an amount of resources requested by the request is available on the network; and
transmitting to the call server a message indicating whether or not the resource allocation request is granted.

25. The method of claim 24, wherein the resource information managed by the call processor comprises data received from the at least one network element.

26. The method of claim 24, further comprising subtracting the amount of resources requested for the call service from the amount of available resources on the network when the request is granted and when the requested resources have been allocated.
